(19) United States
(12) Patent Application Publication
(10) Pub. No.: US 2007/0006471 A1
(43) Pub. Date: Jan. 11, 2007

(54) Light-emitting depth cut gauge

(76) Inventors: Gary Neil Van Trump, Hemet, CA (US); Gregory Neil Van Trump, Sonoma, CA (US); Jeffrey Neil Van Trump, Hughson, CA (US)

Correspondence Address: Raymond M. Galasso;Galasso & Associates LP, P.O. Box 26503, Austin, TX, 78755-0503, US

(21) Appl. No.: 11/176,489

(22) Filed: Jul. 7, 2005

(51) Int. Cl. G01C 5/00

(52) U.S. Cl. 33/290

(57) ABSTRACT

A light-emitting measurement device comprises a support body, a slider apparatus, and a light-emitting device. Measurement indicia are provided on a surface of the support body. The slider apparatus is movably attached to the support body. A pointing member of the slider apparatus is movable along a substantially straight longitudinal reference axis. The light-emitting device is attached to the pointing member. The laser light-emitting device emits light in a direction substantially perpendicular to the longitudinal reference axis. The support body is placed on a work-piece engagement surface that is substantially flat, and has a cutting device opening that extends through the work surface. The light-emitting device emits light in a direction that extends over the cutting device opening such that the pointing member is adjustable to a position whereby the light impinges upon a tip of a cutting device extending through the cutting device opening.

### FIELD OF THE DISCLOSURE

The disclosures made herein relate generally to measurement instruments and, more particularly, to measurement instruments for setting a cut depth.

### BACKGROUND

Craftsmen and tradesmen rely on a variety of tools to complete their jobs quickly and effectively. The ability to measure a piece of work with precision decreases errors and increases productivity. Carpenters in particular desire devices that aid in cutting precise depths into wood with such power tools as radial saws, routers, and table saws.

One conventional measurement technique for setting a cut depth is using a ruler to set measure a position of a blade or bit (i.e., a cutting device) relative to a respective guide, table or base plate (i.e., a reference surface). The ruler is placed perpendicular to the reference surface and the depth of the cutting device relative to the reference surface is measured. This method of measuring and setting a cut depth has several drawbacks that may result in inaccurate measurements and resulting cut depth. A first limitation is of this conventional technique is that, by nature, cutting blades are not perfectly circular. The irregular form of the teeth varies in radius from the center of the blade. However, only the tip of each tooth defines the depth of the cut. Therefore, the blade must be rotated until the tip of the tooth aligns with the edge of the ruler before the depth can be measured. A second limitation of this conventional technique is the position of the ruler may not be perpendicular to the reference surface. A third limitation of this conventional technique is the ruler may not be aligned with the exposed edge of the cutting device (e.g., the radius of a blade). The process is complicated if the cutting device does not project from the reference surface of the tool at a right angle.

Another conventional technique for setting a cut depth is to use a mechanical measurement device that is built into a tool. For example, commercially-available tools such as saws and routers often have a built-in ruler or scale that allow a guide plate or base plate to be set at a particular distance with respect to a blade or bit of the tool. A limitation of these types of built-in mechanical measurement devices is that they provide inferred measurement rather than a direct measurement. Thus, the potential exists for an actual cut depth from the blade or bit to be different, albeit maybe only slightly different, than the depth dimension set via the built-in mechanical measurement device.

Therefore, a measurement device that overcomes the drawbacks associated with conventional approaches for measuring and setting a cut-depth would be useful, advantageous and novel.

### SUMMARY OF THE DISCLOSURE

Embodiments of the present invention enable a person to set a cutting tool depth in a relatively intuitive and swift manner. More specifically, embodiments of the present invention provide for a relatively accurate and precise method for setting cutting tool depth. Accordingly, the present invention advantageously overcomes one or more shortcomings associated with conventional methods of setting cutting tool depth.

In one embodiment of the present invention, a light-emitting measurement device comprises a support body, a slider apparatus, and a light-emitting device. The slider apparatus is movably attached to the support body. A pointing member of the slider apparatus is movable along a substantially straight longitudinal reference axis. The light-emitting device is attached to the pointing member. The light-emitting device emits light in a direction substantially perpendicular to the longitudinal reference axis.

In another embodiment of the present invention, a work surface apparatus for a power tool comprises a work surface body, a measurement device support body, a slider apparatus, and a light-emitting device. The measurement device support body is attached to the work surface body. The slider apparatus is movably attached to the measurement device support body. A pointing member of the slider apparatus is movable along a substantially straight longitudinal reference axis. The light-emitting device is attached to the pointing member. The light-emitting device emits a beam of light in a direction substantially perpendicular to the longitudinal reference axis.

In another embodiment of the present invention, a power tool comprises a work surface body, a motor, a cutting device, a measurement device, a slider apparatus, and a light-emitting device. The work surface body has a substantially flat work-piece engagement surface and a cutting device opening extending through the work-piece engagement surface. The motor is moveably attached to the work surface body. The cutting device is fixedly attached to the motor for enabling rotation of the cutting device. The cutting device extends through the cutting device opening such that a portion of the cutting device is offset from the work-piece engagement surface by a variable distance. The measurement device support body is attached to the work surface body. A slider apparatus is movably attached to the measurement device support body. A pointing member of the slider apparatus is movable along a substantially straight longitudinal reference axis. The light-emitting device is attached to the pointing member. The light-emitting device emits light in a direction substantially perpendicular to the longitudinal reference axis and in a direction that extends over the cutting device opening such that the pointing member is adjustable to a position whereby the light impinges upon a tip of the cutting device.

Turning now to specific aspects of the present invention, in at least one embodiment, measurement indicia are provided on a surface of the support body.

In at least one embodiment of the present invention, the work surface body has a substantially flat work-piece engagement surface and a cutting device opening extends through the work-piece engagement surface.

In at least one embodiment of the present invention, the light-emitting device emits light in a direction that extends over the cutting device opening such that the pointing member is adjustable to a position whereby the light impinges upon a tip of a cutting device extending through the cutting device opening.

In at least one embodiment of the present invention, the support body is an enclosure.

In at least one embodiment of the present invention, the enclosure includes an elongated window extending through a surface thereof.

In at least one embodiment of the present invention, the pointing member extends through the elongated window.

In at least one embodiment of the present invention, the measurement indicia are adjacent an edge of the elongated window.

In at least one embodiment of the present invention, the slider apparatus includes a helical screw member rotatable about the longitudinal reference axis.

In at least one embodiment of the present invention, the pointer member is engaged with threads of the helical screw member such that rotation of the helical screw member provides for corresponding movement of the pointing member along the longitudinal reference axis.

In at least one embodiment of the present invention, the light-emitting device includes a laser light source.

In at least one embodiment of the present invention, the laser light source is directly mounted on the pointing member.

These and other objects, embodiments advantages and/or distinctions of the present invention will become readily apparent upon further review of the following specification and associated drawings.

### BRIEF DESCRIPTION OF THE DRAWINGS

FIG. 1 depicts a power tool having a light-emitting measurement device in accordance with the present invention associated therewith.

FIG. 2 is a cross sectional view taken along the line 2-2 in FIG. 1.

### DETAILED DESCRIPTION OF THE DRAWING FIGURES

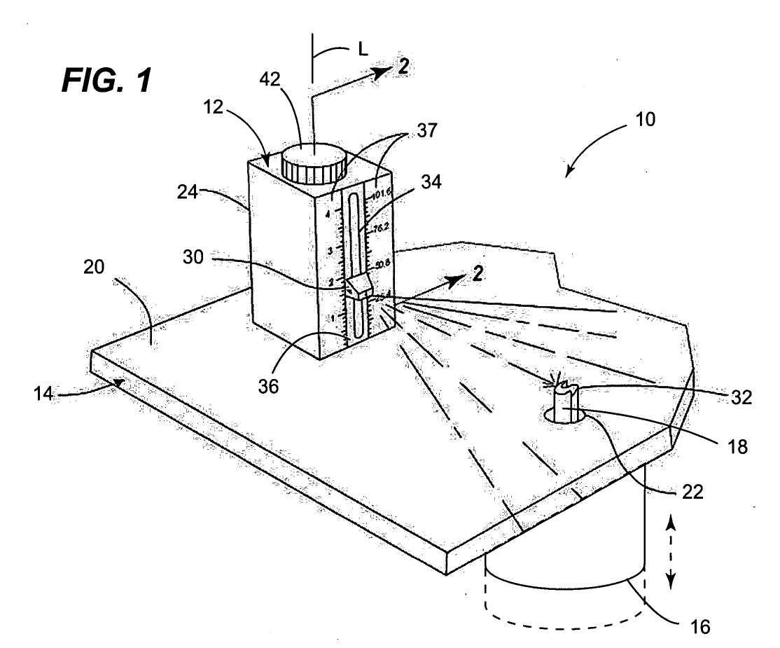

FIG. 1 depicts an embodiment of a power tool 10 having a light-emitting measurement device 12 in accordance with the present invention associated therewith. The power tool 10 includes a work surface body 14, a motor 16 and a cutting device 18. The work surface body 14 has a substantially flat work-piece engagement surface 20 and a cutting device opening 22 extending through the work surface body 14. The motor 16 is moveably attached to the work surface body 14 for enabling vertical displacement of the cutting device 18 relative to the work-piece engagement surface 20. The cutting device 18 is fixedly attached to the motor 16 for enabling rotation of the cutting device 18. The cutting device 18 extends through the cutting device opening 22 such that a portion of the cutting device 18 is offset from the work-piece engagement surface 20 by a variable distance.

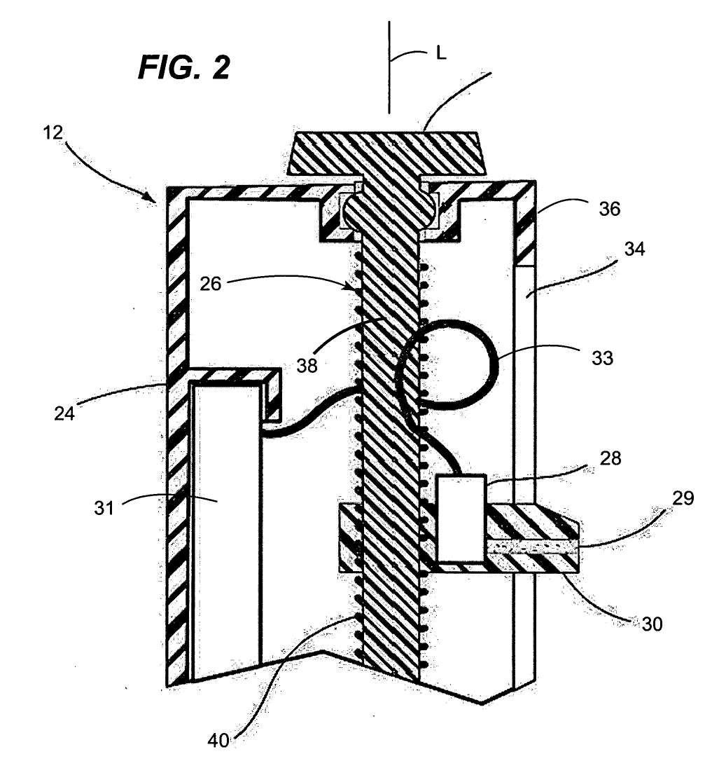

Referring now to FIGS. 1 and 2, the light-emitting measurement device 12 includes a support body 24, a slider apparatus 26, and a light-emitting device 28. Light from the light-emitting device 28 is optionally channelled through a light-conducting member 29 (e.g., an optical fiber or light pipe). The slider apparatus 26 is movably attached to the support body 24. A pointing member 30 of the slider apparatus 26 is movable along a substantially straight longitudinal reference axis L. The light-emitting device 28 is attached to the pointing member 30, with the pointing member 30 indicating a distance of the light-emitting device 28 from a work-piece engagement surface 20. The light-emitting device 28 emits light (e.g., a fan-shaped substantially planar beam of light or a substantially straight beam of light) in a direction substantially perpendicular to the longitudinal reference axis L, and therefore substantially parallel to the work-piece engagement surface 20. A power source 31 (e.g., a battery 31) and power transmission means 33 (e.g., wires) facilitate delivering power to the light-emitting device 28.

The support body 24 of the light-emitting measurement device 12 is engaged with the work surface body 14. For example, the support body 24 may be attached to the work surface body 14 or movably positioned on the work-piece engagement surface 20 of the work surface body 14. It is disclosed herein that a work surface apparatus in accordance with the present invention comprises the light-emitting measurement device 12 and the work surface body 14 having the light-emitting measurement device attached thereto. In this manner, the pointing member 30 is adjustable to a position whereby the light emitted by the light-emitting device 28. impinges upon a tip 32 of the cutting device18.

As depicted, the support body 24 is an enclosure. However, the support body 24 could alternately be a generally open structure. The support body 24 includes an elongated window 34 extending through a generally vertical surface 36 of the support body 24. The pointing member 30 extends through the elongated window 34. Measurement indicia 37 are provided on a surface of the support body 12 adjacent an edge of the elongated window 34.

The slider apparatus 26 includes a helical screw member 38 rotatable about the longitudinal reference axis L. The pointer member 30 is engaged with threads 40 of the helical screw member 38 such that rotation of the helical screw member 34 provides for corresponding movement of the pointing member 30 along the longitudinal reference axis L. A knob 42 enables the user to rotate the helical screw member 38 and thus, move the pointer member 30 along the longitudinal reference axis L within the limits of the elongated window 34.

In accordance with the present invention, a beam of light is a beam of light that is focused, monochromatic and/or coherent beam of light such as that produced, for example, by a laser device. A laser device is a preferred embodiment of a light-emitting device in accordance with the present invention. However, it is disclosed herein that non-laser types of light emitting devices may be implemented for producing a suitable beam of light. For example, a non-laser light may be conditioned via one or more filters and or lenses for producing such a suitable beam of light.

It is contemplated herein that the measurement indicia 37 may be replaced with a digital display. Such a display could be reset at any point along the longitudinal reference axis to display depths referenced to points other than the work-piece engagement surface 20.

The slider apparatus 14 is depicted as being restricted to non-linear movement by, for example, the elongated window 34 in the support body 24. However, it is disclosed herein that other means may be implemented to restrict non-linear movement. For example, the pointer member 30 may move along a straight cylindrical tube. It is contemplated herein that the slider apparatus 14 could be of a direct linear movement and undesired movement relative to the support body 12 restricted via a locking action or static friction rather than a helical screw member 38.

As depicted in FIG. 1, the horizontal movement of the motor 16 and cutting device 18 is precluded relative to the work-piece engagement surface 20. However, it is contemplated herein that work piece may be attached to work-piece engagement surface 20 via a clamp or vice, and the motor 16 and the cutting device 18 moved in a horizontal plane relative to the work-piece engagement surface 20. Additionally, the cutting device 18 is depicted as engaging the work piece from below the work piece (i.e., relative to the work-piece engagement surface 20). However, it is disclosed herein that the cutting device 18 may engage the work piece from above, such as in a milling machine or drill press. In such an embodiment, the motor 16 and the cutting device 18 are positioned above the work-piece engagement surface 20.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A light-emitting measurement device, comprising:
a support body;
a slider apparatus movably attached to the support body, wherein a pointing member of the slider apparatus is movable along a substantially straight longitudinal reference axis; and
a light-emitting device attached to the pointing member, wherein the light-emitting device emits light in a direction substantially perpendicular to said longitudinal reference axis.

2. The light-emitting measurement device of claim 1, further comprising:
measurement indicia provided on a surface of the support body.

3. The light-emitting measurement device of claim 2 wherein:
the support body is an enclosure;
the enclosure includes an elongated window extending through a surface thereof;
the pointing member extends through the elongated window; and
said measurement indicia is adjacent an edge of the elongated window.

4. The light-emitting measurement device of claim 1 wherein:
the slider apparatus includes a helical screw member rotatable about said longitudinal reference axis; and
the pointer member is engaged with threads of the helical screw member such that rotation of the helical screw member provides for corresponding movement of the pointing member along said longitudinal reference axis.

5. The light-emitting measurement device of claim 1 wherein the light-emitting device includes a laser light source.

6. The light-emitting measurement device of claim 5 wherein the laser light source is directly mounted on the pointing member.

7. The light-emitting measurement device of claim 1, further comprising:
measurement indicia provided on a surface of the support body;
wherein the support body is an enclosure;
wherein the enclosure includes an elongated window extending through a surface thereof;
wherein the pointing member extends through the elongated window; and
wherein said measurement indicia is adjacent an edge of the elongated window;
wherein the slider apparatus includes a helical screw member rotatable about said longitudinal reference axis;
wherein the pointer member is engaged with threads of the helical screw member such that rotation of the helical screw member provides for corresponding movement of the pointing member along said longitudinal reference axis;
wherein the light-emitting device includes a laser light source; and
wherein the laser light source is directly mounted on the pointing member.

8. A work surface apparatus for a power tool, comprising:
a work surface body;
a measurement device support body attached to the work surface body;
a slider apparatus movably attached to the measurement device support body, wherein a pointing member of the slider apparatus is movable along a substantially straight longitudinal reference axis; and
a light-emitting device attached to the pointing member, wherein the light-emitting device emits a beam of light in a direction substantially perpendicular to said longitudinal reference axis.

9. The work surface apparatus of claim 8 wherein:
the work surface body has a substantially flat work-piece engagement surface and a cutting device opening extends through said work-piece engagement surface; and
the light-emitting device emits light in a direction that extends over the cutting device opening such that the pointing member is adjustable to a position whereby said light impinges upon a tip of a cutting device extending through the cutting device opening.

10. The work surface apparatus of claim 8, further comprising:
measurement indicia provided on a surface of the support body.

11. The work surface apparatus of claim 10 wherein:
the support body is an enclosure;
the enclosure includes an elongated window extending through a surface thereof;
the pointing member extends through the elongated window; and
said measurement indicia is adjacent an edge of the elongated window.

12. The work surface apparatus of claim 8 wherein:
the slider apparatus includes a helical screw member rotatable about said longitudinal reference axis; and
the pointer member is engaged with threads of the helical screw member such that rotation of the helical screw member provides for corresponding movement of the pointing member along said longitudinal reference axis.

13. The work surface apparatus of claim 8 wherein the light-emitting device includes a laser light source.

14. The work surface apparatus of claim 13 wherein the laser light source is directly mounted on the pointing member.

15. The work surface apparatus of claim 8, further comprising:
measurement indicia provided on a surface of the support body;
wherein the work surface body has a substantially flat work-piece engagement surface and a cutting device opening extends through said work surface;
wherein the light-emitting device emits light in a direction that extends over the cutting device opening such that the pointing member is adjustable to a position whereby said light impinges upon a tip of a cutting device extending through the cutting device opening;
wherein the support body is an enclosure;
wherein the enclosure includes an elongated window extending through a surface thereof;
wherein the pointing member extends through the elongated window;
wherein said measurement indicia is adjacent an edge of the elongated window
wherein the slider apparatus includes a helical screw member rotatable about said longitudinal reference axis;
wherein the pointer member is engaged with threads of the helical screw member such that rotation of the helical screw member provides for corresponding movement of the pointing member along said longitudinal reference axis;
wherein the light-emitting device includes a laser light source; and
wherein the laser light source is directly mounted on the pointing member.

16. A power tool, comprising:
a work surface body having a substantially flat work-piece engagement surface and a cutting device opening extending through said work-piece engagement surface;
a motor moveably attached to the work surface body;
a cutting device fixedly attached to the motor for enabling rotation of the cutting device, wherein the cutting device extends through the cutting device opening such that a portion of the cutting device is offset from said work-piece engagement surface by a variable distance;
a measurement device support body attached to the work surface body;
a slider apparatus movably attached to the measurement device support body, wherein a pointing member of the slider apparatus is movable along a substantially straight longitudinal reference axis; and
a light-emitting device attached to the pointing member, wherein the light-emitting device emits light in a direction substantially perpendicular to said longitudinal reference axis and in a direction that extends over the cutting device opening such that the pointing member is adjustable to a position whereby said light impinges upon a tip of the cutting device.

17. The power tool of claim 16, further comprising:
measurement indicia provided on a surface of the support body.

18. The power tool of claim 17 wherein:
the support body is an enclosure;
the enclosure includes an elongated window extending through a surface thereof;
the pointing member extends through the elongated window; and
said measurement indicia is adjacent an edge of the elongated window.

19. The power tool of claim 18 wherein:
the slider apparatus includes a helical screw member rotatable about said longitudinal reference axis; and
the pointer member is engaged with threads of the helical screw member such that rotation of the helical screw member provides for corresponding movement of the pointing member along said longitudinal reference axis.

20. The power tool of claim 19 wherein the light-emitting device includes a laser light source.
